(19) United States
(12) Patent Application Publication
(10) Pub. No.: US 2007/0084099 A1
(43) Pub. Date: Apr. 19, 2007

(54) Toilet paper for potty training

(76) Inventors: Benjamin Charles Sarbo, Winneconne, WI (US); Bart John Rabas, Appleton, WI (US); Heather Anne Sorebo, Appleton, WI (US)

Correspondence Address: KIMBERLY-CLARK WORLDWIDE, INC., 401 NORTH LAKE STREET, NEENAH, WI, 54956, US

(21) Appl. No.: 11/251,269

(22) Filed: Oct. 13, 2005

(51) Int. Cl. G09F 3/10

(52) U.S. Cl. 40/674

(57) ABSTRACT

Toilet paper contains a repeating graphic pattern that is designed to help children learn to use a proper amount of toilet paper for cleaning. The repeating graphic pattern contains a series of relatively small clue-like objects (such as puppy paw prints) which extend over several consecutive individual toilet paper sheets and which lead to a relatively large target object (such as a puppy), where the toilet paper is to be torn.

### BACKGROUND OF THE INVENTION

Parents of young children are often frustrated with their child's use of too much or too little toilet paper. The use of too much toilet paper results in wasted money as well as potentially clogged toilets. The use of too much toilet paper can also lead to children being unable to properly cleanse themselves because they are not able to fit a large wad of toilet paper where it needs to be placed for effective cleaning. This can result in streaked underwear and make laundry time more difficult for their parents. The use of too little toilet paper can result in children ending up with messy hands and unsanitary bathroom conditions if they touch other items, as well as also causing streaked underwear. In addition, children also can get frustrated and lack confidence because they are not sure how to get the correct amount of toilet paper when their parents tell them to use a specified amount.

There are many ways that one can teach a child how to meter dry toilet paper. However, many of them lack many of the key ingredients in making it intuitive for the youngest children but still attractive to older children and adults.

### SUMMARY OF THE INVENTION

A graphical means of helping children (and potentially others who may need a visual reminder of the correct amount of toilet paper to use) to dispense the right amount of toilet paper has now been discovered which: (1) is very intuitive for a large age range; (2) consistently delivers the proper amount of toilet paper for good cleaning; and (3) is aesthetically pleasing to parents and children.

Hence, in one aspect the invention resides in a roll of toilet paper comprising a wound length of paper having multiple spaced-apart perforation lines, wherein said wound length of paper contains a repeating graphic pattern containing a series of relatively small clue-like objects which lead to a relatively large target object as the roll is unwound. Suitably, the multiple spaced-apart perforation lines define individual sheets within the wound length of paper of a size typically found in rolls of toilet paper. Ordinarily, the length of a typical sheet of toilet paper is about four inches. However, for purposes of this invention, the perforation lines can be spaced apart any distance up to the-length of paper intended to be used for a single wiping. In use, the child or other user unwinds the roll of toilet paper and follows the clue-like objects until the target object is exposed and then tears the paper at some point at or preferably just beyond the target object such that the length of toilet paper removed essentially contains about one repeat length of the graphic pattern. The repeat length of the graphic pattern is designed to be about the right amount of toilet paper to be used for a single wipe. If multiple wipes are necessary, which are more likely with a bowel movement versus urination occasion, the graphic pattern is designed to be the right amount for each wiping occasion. It is not necessary for the repeating graphic pattern to be in registration with the perforation lines, although it can be if desired. The number of instances within a given roll of toilet paper that the perforation line extends through the target object is not significant and can in part be controlled by the size of the target object and the size of the individual sheets.

The advantages of this invention may include one or more of the following:

1) The change in size is a strong visual indicator to children that they have reached their target. While providing graphics in which all of the objects are of the same size could also serve the purpose of conveying the proper amount to use, it would not be as intuitive, especially for younger children.

2) Including small clues as to what the individual is looking for provides a fun, game-like addition to dispensing and is a powerful way to engage children who are drawn to games and puzzles that make them become a “detective.” In accordance with this invention, children are able to define the end point very easily based on the graphic design. The number of small clue-like objects can be added or deleted based on the appropriate amount of toilet paper for target age groups.

3) Not all children (especially young children) are capable of identifying numbers, letters, colors or animals. However, detecting a visual change in size of the object and/or combined with puzzle solving is easier for children to comprehend and identify.

4) The use of smaller images for the majority of the sheets decreases the amount of ink that is needed. Parents' concerns as to the safety of the product because of the amount of ink coming in contact with the skin are eased by the decreased amount of ink needed for the smaller images. The use of smaller images also allows for continuous printing of toilet paper and increases the appeal for children who like the vivid colorful prints rather than large areas of unprinted tissue. In addition, the use of smaller images lowers manufacturing costs because less ink is needed. Since the pattern does not get lost in lots of colors/patterns, it is more visually noticeable.

5) The graphics in accordance with this invention allow for a more aesthetically pleasing product. Parents indicate that they do not want to use a product that is soaked with lots of ink and screams that it is a “product for kids.” Small objects like bubbles or flower petals showing on the toilet paper roll as it sits on the dispenser are much more subtle than large printed objects and minimize embarrassment when used by older children. The toilet paper roll appeals to older children as a game and not as a “baby” product.

6) The graphics do not rely on the location of the perforations in the sheet to be effective. A child can tear above the large target object at the next closest perforation line to consistently measure the right amount of toilet paper each time.

The small clue-like objects and the relatively large target object are preferably of related subject matter. For example, specific combinations of small clue-like objects and relatively large target objects respectively include, without limitation: foot prints and an animal (including a cartoon animal); paw prints and a dog, such as a puppy; paw prints and a bear; lily pads and a frog or turtle; bubbles and a fish; flower petals or leaves and a bouquet of flowers; hearts and a princess; crowns with wands and a princess; and the like. The small clue-like objects can all be the same or different from each other in some way. For example, some small clue-like objects can be larger than others, some can be oriented differently, or some can be entirely different objects.

The size of the clue-like objects is noticeably smaller than the target object in order to make it clear to the child where to tear the wound length of paper. In embodiments of the invention where the clue-like objects are footprints, their size can be similar to the foot size of the animal or character of the target object. Alternatively, or in other embodiments where the clue-like objects and the target objects do not have a such a direct subject matter correlation, the relative sizes can be arbitrary. Quantitatively, without limitation, using the surface area within the periphery of the objects as a measure of their size, the ratio of the size of the target object relative to the size of a clue-like object can be from about 3:1 to about 50:1, more specifically from about 10:1 to about 40:1, and still more specifically from about 20:1 to about 40:1.

The size of a clue-like object, as measured by the surface area within its periphery, can be from about 0.5 to about 20 square centimeters, more specifically from about 0.5 to about 7 square centimeters, and still more specifically from about 1 to about 4 square centimeters.

The number of clue-like objects in the graphic repeating pattern can be from about 5 to about 25 or more, more specifically from about 10 to about 25, and still more specifically from about 15 to about 20. If the number of clue-like objects is too few or too many, they can lose their interest or effect of “leading” to the target object. Advantageously, the series of small clue-like objects within each graphic repeating pattern occupies from 3 to 9 individual sheets, more specifically 3 to 7 individual sheets, and still more specifically from 4 to 6 individual sheets. Stated differently, the series of relatively small clue-like objects has a length from about 10 to about 40 inches, more specifically from about 12 to about 30 inches, and still more specifically from about 15 to about 25 inches.

The size of the target object, also as measured by the surface area within its periphery, can be from about 15 to about 90 square centimeters, more specifically from about 20 to about 75 square centimeters, more specifically from about 25 to about 50 square centimeters and still more specifically from about 30 to about 45 square centimeters. The size of the target object should be less than the size of an individual sheet.

The graphic repeat patterns can be applied to the toilet paper in any suitable manner well known to those familiar with tissue making, such as by gravure printing. The graphics can be multi-colored. The color(s) of the clue-like objects can be the same or different than the color(s) of the target object. Suitably, the target object may have more colors to enhance its appeal.

### BRIEF DESCRIPTION OF THE DRAWINGS

FIGS. 1-8 are examples of graphic patterns for various embodiments in accordance with this invention, illustrating multiple clue-like objects leading to the target object. In all of the figures, the spaced-apart perforation lines are represented by the dashed lines. The figures specifically represent toilet paper having an individual sheet width of about 4.5 inches and an individual sheet length (distance between perforation lines) of about 4 inches. The sizes of the various graphic elements within the sheets are to scale.

### DETAILED DESCRIPTION OF THE DRAWING

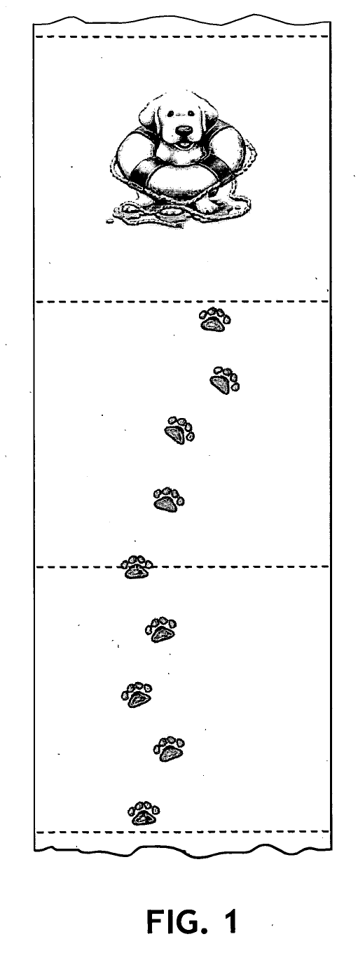

FIG. 1 shows four sheets of toilet paper in which the clue-like objects are puppy paws and the target object is a puppy with a life ring. The area of each of the puppy paws is about 1.5 square centimeters and the area of the puppy target object is about 36 square centimeters.

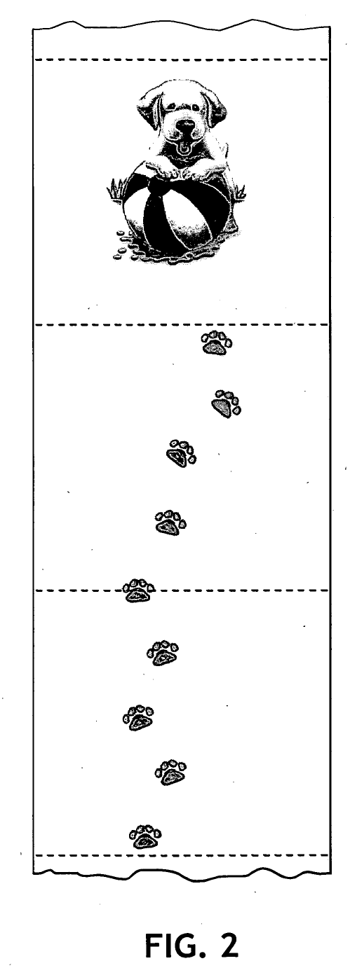

FIG. 2 shows four sheets of toilet paper in which the clue-like objects are puppy paws and the target object is a puppy with a beach ball. The area of each of the puppy paws is about 1.5 square centimeters and the area of the target object is about 42 square centimeters.

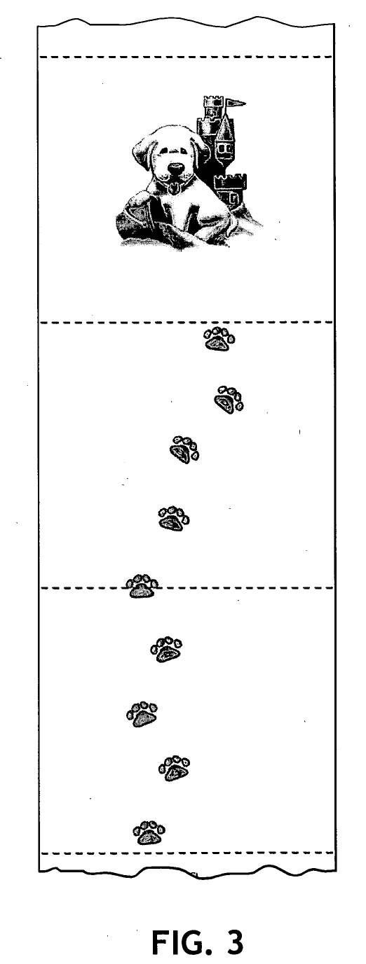

FIG. 3 shows four sheets of toilet paper in which the clue-like objects are puppy paws and the target object is a puppy with a sand castle. The area of each of the puppy paws is about 1.5 square centimeters and the area of the target object is about 36 square centimeters.

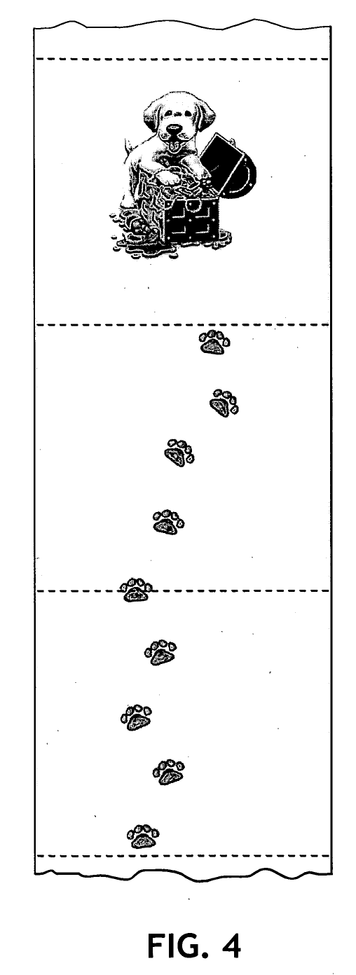

FIG. 4 shows four sheets of toilet paper in which the clue-like objects are puppy paws and the target object is a puppy with a life treasure chest. The area of each of the puppy paws is about 1.5 square centimeters and the area of the target object is about 39 square centimeters.

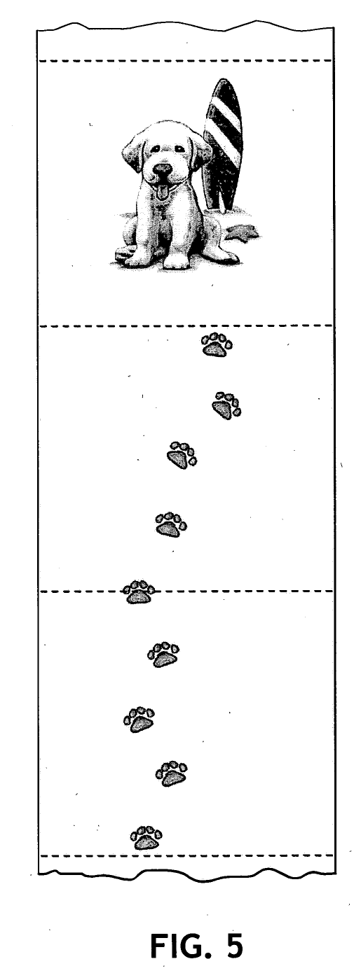

FIG. 5 shows four sheets of toilet paper in which the clue-like objects are puppy paws and the target object is a puppy with a surf board. The area of each of the puppy paws is about 1.5 square centimeters and the area of the target object is about 45 square centimeters.

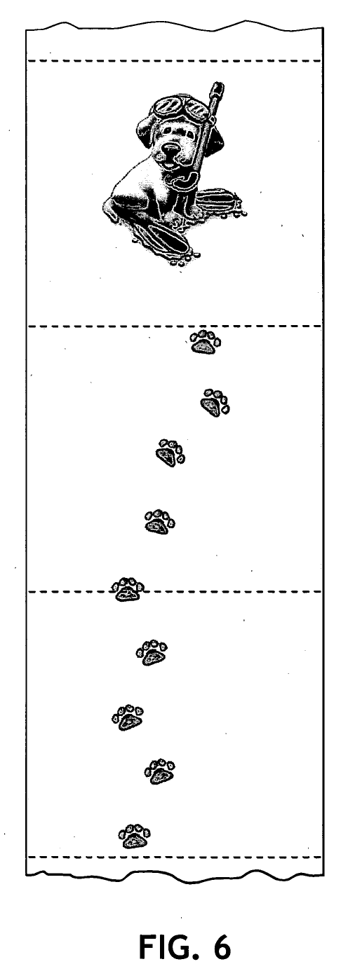

FIG. 6 shows four sheets of toilet paper in which the clue-like objects are puppy paws and the target object is a puppy with a snorkel and flippers. The area of each of the puppy paws is about 1.5 square centimeters and the area of the target object is about 42 square centimeters.

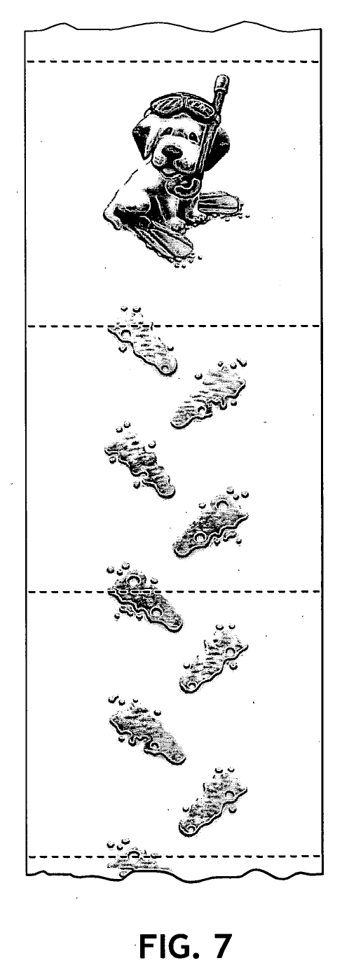

FIG. 7 shows four sheets of toilet paper in which the clue-like objects are wet flipper footprints and the target object is a puppy with a snorkel and flippers. The area of each of the clue-like objects is about 6 square centimeters and the area of the puppy target object is about 42 square centimeters.

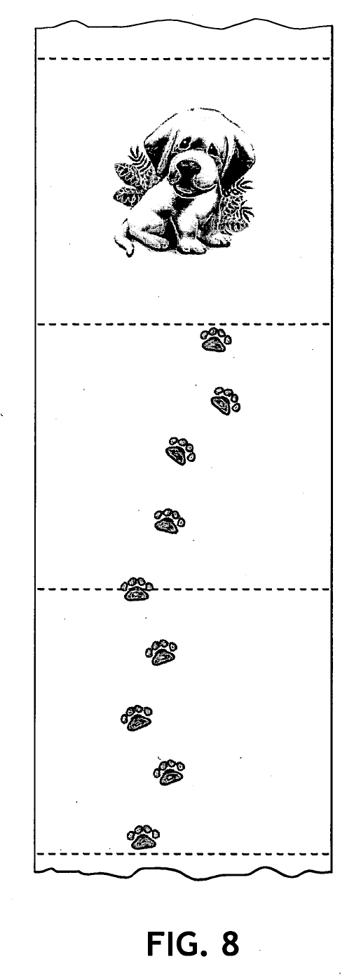

FIG. 8 shows four sheets of toilet paper in which the clue-like objects are puppy paws and the target object is a puppy with a leaf background. The area of each of the puppy paws is about 1.5 square centimeters and the area of the target object is about 30 square centimeters.

It will be appreciated that the foregoing description and examples are for purposes of illustration only and are not to be construed as limiting the scope of the invention, which is defined by the following claims.

We claim:

1. A roll of toilet paper comprising a wound length of paper having multiple spaced-apart perforation lines, wherein said wound length of paper contains a repeating graphic pattern containing a series of relatively small clue-like objects which lead to a relatively large target object as the roll is unwound.

2. The roll of toilet paper of claim 1 wherein the perforation lines define individual sheets and the relatively small clue-like objects of the graphic pattern extend over three or more individual sheets.

3. The roll of toilet paper of claim 2 wherein the series of relatively small clue-like objects occupies from 3 to 9 individual sheets.

4. The roll of toilet paper of claim 2 wherein the series of relatively small clue-like objects occupies from 3 to 7 individual sheets.

5. The roll of toilet paper of claim 2 wherein the series of relatively small clue-like objects occupies from 4 to 6 individual sheets.

6. The roll of toilet paper of claim 1 wherein the series of relatively small clue-like objects has a length from about 10 to about 40 inches.

7. The roll of toilet paper of claim 1 wherein the series of relatively small clue-like objects has a length from about 12 to about 30 inches.

8. The roll of toilet paper of claim 1 wherein the series of relatively small clue-like objects has a length from about 15 to about 25 inches.

9. The roll of toilet paper of claim 1 wherein the ratio of the size of the target object relative to the size of a clue-like object is from about 3:1 to about 50:1.

10. The roll of toilet paper of claim 1 wherein the size of a clue-like object is from about 0.5 to about 20 square centimeters.

11. The roll of toilet paper of claim 1 wherein the number of clue-like objects in the graphic repeating pattern is from about 5 to about 25.

12. The roll of toilet paper of claim 1 wherein the size of the target object is from about 15 to about 90 square centimeters.

13. The roll of toilet paper of claim 1 wherein the relatively small clue-like objects are paw prints.

14. The roll of toilet paper of claim 1 wherein the relatively large target object is an animal.

15. The roll of toilet paper of claim 1 wherein the relatively large target object is a dog.

16. The roll of toilet paper of claim 1 wherein the relatively large target object is a frog.

17. The roll of toilet paper of claim 1 wherein the relatively large target object is a bear.

18. The roll of toilet paper of claim 1 wherein the relatively large target object is a princess.

19. The roll of toilet paper of claim 1 wherein the relatively large target object is a bouquet of flowers.
